(19) United States
(12) Patent Application Publication
(10) Pub. No.: US 2024/0329249 A1
(43) Pub. Date: Oct. 3, 2024

(54) PULSED LIDAR SYSTEM

(71) Applicant: OFFICE NATIONAL D'ETUDES ET DE RECHERCHES AÉROSPATIALES, PALAISEAU (FR)

(72) Inventor: Laurent LOMBARD, PALAISEAU (FR)

(21) Appl. No.: 18/558,997

(22) PCT Filed: Apr. 26, 2022
(86) PCT No.: PCT/FR2022/050782

§ 371 Date: Nov. 3, 2023

(30) Foreign Application Priority Data
May 6, 2021 (FR) 2104770

(51) Int. Cl. G01S 17/58; G01S 7/481; G01S 7/484; G01S 7/486; G01S 17/95

(52) U.S. Cl. CPC G01S 17/58; G01S 7/484; G01S 7/486; G01S 17/95; G01S 7/4818

(57) ABSTRACT

A pulsed LIDAR system has a transmission path which is configured so that two pulses which are successively emitted are spectrally disjoint and associated with different respective central wavelength values. A signal-to-noise ratio of a heterodyne detection signal is improved in this manner. A LIDAR system of this kind can be implemented using optical fibers, and is particularly suitable for airspeed measurements.

### TECHNICAL FIELD

This description relates to a pulsed LIDAR system, in particular such a LIDAR system which is adapted to perform airspeed measurements. Although LIDAR is the acronym for Light Detection And Ranging, LIDAR systems are highly suitable for carrying out speed measurements at a distance.

### PRIOR ART

Determining the wind speed at a distance is useful in many fields, particularly aviation safety, for example in order to detect the presence of turbulence near airport runways, or to detect gusts of wind when on board an aircraft in flight in order to compensate for the effects of premature wear caused by gusts on the aircraft's structures. Other areas where such knowledge is also useful are the surveying and management of wind farm sites, or the measurement of atmospheric currents from space for weather forecasts.

In a known manner, a pulsed LIDAR system makes it possible to measure the speed component of a target which is parallel to the direction of emission of the LIDAR system, as well as the distance separating the target from the LIDAR system. In particular, a pulsed LIDAR system which is configured for airspeed measurements makes it possible to obtain estimates of the wind speed component that is parallel to the direction of emission of the LIDAR system, as a function of the separation distance measured along this direction of emission. However, for such airspeed measurements, the signals which are detected by the LIDAR system and from which the measurement results for the wind speed are obtained, are produced by a backscattering of the emitted pulses which is caused by particles suspended in the air. These detection signals have very low intensities, so it is important to improve the signal-to-noise ratio associated with them.

Also in a known manner, when the pulsed LIDAR system uses heterodyne detection, meaning when the system is coherent between emission and detection, its signal-to-noise ratio is proportional to E·PRF^{1/2}, where E is the energy of each pulse that is backscattered then detected, and PRF is the pulse repetition frequency. Efforts are therefore made to increase the values for the energy E and frequency PRF.

Increasing the energy E could be achieved by increasing the energy of each pulse as emitted by the LIDAR system. Indeed, the radiation is initially produced by a laser source, which in itself does not place a limitation on the power of the radiation emitted towards the outside. However, implementation of the LIDAR system by using optical fiber connection technology offers considerable advantages, in particular an increased robustness of the system and the elimination of mechanisms for aligning the optical components of the system relative to each other. But the known phenomenon of stimulated Brillouin scattering, or SBS, which occurs in optical fibers limits the peak power value that each emitted pulse can have.

Furthermore, the frequency PRF is limited by the range of the LIDAR system. Indeed, it is necessary that a pulse of radiation emitted towards the target be detected in return before the next pulse is emitted, in order to correlate each detected radiation portion with the correct moment of pulse emission, so as to deduce from this the value for the distance away from the target. In other words, the frequency PRF is limited by the range L stipulated for the LIDAR system according to the formula: PRF<C/(2·L), where C is the speed of light.

Thus, these limitations on the energy of the emitted pulses and on the repetition frequency of the pulses, because of the resulting consequences for the signal-to-noise ratio of the heterodyne detection signals, prevent improving the precision of the measurement results, in particular airspeed measurement results.

### Technical Problem

Based on this situation, one object of the present invention is to propose a new pulsed LIDAR system, in which the signal-to-noise ratio of the detection signals is improved.

A complementary object of the invention is for such a LIDAR system to be compatible with the use of optical fibers to interconnect the optical components inside the LIDAR system.

Another complementary object of the invention is for such a LIDAR system to be adapted for airspeed measurements.

### SUMMARY OF THE INVENTION

To achieve at least one of these or other objects, one aspect of the invention proposes a pulsed LIDAR system which is adapted to determine a value of a Doppler effect frequency shift undergone by a series of radiation pulses successively emitted by the system towards a target, between portions of the pulses as received after retroreflection or backscattering on the target and the same pulses as emitted by the system. The system then provides, based on the value determined for the frequency shift, an estimate of a speed component of the target which is parallel to an optical direction of emission of the system. For this purpose, the system comprises:
a transmission path, configured to produce the series of pulses,
a detection path, configured to detect the pulse portions received after retroreflection or backscattering on the target, and to produce heterodyne detection signals which correspond to the pulses of the series, and
a spectral analysis module, adapted to carry out a spectral analysis of the heterodyne detection signals, so that the value of the frequency shift results from heterodyne detection contributions which correspond to the pulses of the series.

The use of multiple pulses to perform the spectral analysis provides an initial improvement in the signal-to-noise ratio, and the accuracy of the measurement results provided by the LIDAR system is improved accordingly.

According to the invention, the LIDAR system has the following additional characteristics:
the transmission path is further configured so that two pulses successively emitted towards the target are spectrally disjoint and associated with respective central wavelength values which are different, and
the system is adapted so that the value of the frequency shift which is determined by the spectral analysis module results from a combination of several heterodyne detection contributions which respectively correspond to the spectrally disjoint pulses and for which the central wavelength values are different.

In the context of the invention, pulses which are spectrally disjoint is understood to mean pulses whose respective spectra do not overlap, meaning there is no wavelength interval where the respective spectral intensities of several of the pulses are greater than 1% of a maximum spectral intensity value of each of the pulses.

Thus, two pulses successively emitted by the LIDAR system of the invention are distinguished by respective spectral intervals which are different. The same distinction then exists between the pulse portions received after retroreflection or backscattering on the target, so that the system is capable of assigning each pulse portion received after retroreflection or backscattering to the emitted pulse which corresponds to it, independently of the fact that another pulse has been emitted in the meantime. Thus, by means of the spectral differentiation which is introduced by the invention between successive pulses, the pulse repetition frequency PRF can be increased without reducing the range L of the LIDAR system.

Furthermore, each pulse can still have a peak power value that is just below a suitable threshold for stimulated Brillouin scattering. Then, with regard to the determination of the frequency shift value, combining the heterodyne detection contributions which respectively correspond to spectrally disjoint pulses and for which the central wavelength values are different is equivalent to increasing the repetition frequency PRF. An additional improvement results for the signal-to-noise ratio relative to the heterodyne detection signal, which is proportional to the square root of the increase in the repetition frequency PRF provided by the operation of the LIDAR system of the invention. The accuracy in the value obtained for the Doppler effect frequency shift is increased accordingly. According to another point of view, for a constant value of the range L, and while maintaining identical precision in the measurement results, the LIDAR system of the invention can make it possible to reduce the accumulation time for the heterodyne detection signal by a factor which is equal to the number of different central wavelength values for the pulses.

The fact that the peak power value of each pulse remains below the stimulated Brillouin scattering threshold makes it possible to use optical fiber technology to implement its transmission path.

In addition, all the heterodyne detection contributions which respectively correspond to the spectrally disjoint pulses and for which the central wavelength values are different, can contribute to obtaining the value of the frequency shift attributed to the Doppler effect produced by the target's movement. Thus, the system of the invention can have an operation in which the repetition frequency PRF which is in effect is multiplied by the number of different central wavelength values for the pulses, while maintaining an unchanged value for the range L of the LIDAR system.

Thus, the invention provides a LIDAR system which determines the value of the Doppler effect frequency shift based on a plurality of spectral contributions present in the heterodyne detection signal. These spectral contributions, which constitute just as many spectrally separate components in the heterodyne detection signal, correspond one-to-one to the central wavelength values of the pulses emitted towards the target, which differ between two successive pulses. For example, an elementary value can be determined for the Doppler effect frequency shift based on each heterodyne detection spectral contribution, independently of the other heterodyne detection spectral contributions, and then a final value for the Doppler effect frequency shift can be calculated by averaging the elementary values.

In general for the invention, the transmission path of the LIDAR system of the invention may comprise:
a laser emission source, adapted to produce an initial laser radiation, this initial laser radiation preferably being monochromatic or quasi-monochromatic;
at least one modulator, arranged to modify the initial laser radiation in accordance with a modulation signal applied to at least one control input of this modulator; and
a controller, connected so as to apply the modulation signal to the at least one control input of the modulator.
   The modulation signal is then such that the initial laser radiation is transformed by the modulator into the series of pulses in which two successive pulses are spectrally disjoint and have central wavelength values which are different. Furthermore, a reference input of the detection path, which is used for heterodyne detection, can be connected to a secondary output of the transmission path which is located between the laser emission source and the modulator. The optical reference signal, which is used for heterodyne detection, can then be monochromatic. In the heterodyne detection signal as produced by the detection path, the heterodyne detection contributions which result from the spectrally disjoint pulses and for which the central wavelength values are different, are then spectrally shifted relative to each other. In other words, these heterodyne detection contributions have respective central frequency values which are also different. The spectral analysis module then deduces the value of the Doppler effect frequency shift from all these different central frequency values for the heterodyne detection contributions.

Alternatively, but in a less preferred manner, the secondary output of the transmission path, to which the reference input of the detection path is connected in order to obtain the heterodyne detection, can be located downstream of the modulator relative to a direction of propagation of the radiation in the transmission path.

In first embodiments of the invention, the transmission path may be configured to produce, by serrodyne modulation, successive pulses which are spectrally disjoint and for which the central wavelength values are different. To achieve this, the modulator may be a phase modulator, and the modulation signal may be a phase modulation signal composed of temporally disjoint sequences of linear phase-shift ramps, the linear phase-shift ramps being identical and successive within each sequence and having different slopes between different sequences. The sequences of linear phase-shift ramps then correspond one-to-one to the pulses emitted by the LIDAR system. For such first embodiments with serrodyne modulation, the phase modulator which is used may be an electro-optical type modulator.

In second embodiments of the invention, the transmission path may be configured to produce successive pulses, by I/Q modulation, which are spectrally disjoint and for which the central wavelength values are different. To achieve this, the modulator may comprise a recombination Mach-Zehnder interferometer, and two secondary Mach-Zehnder interferometers which are arranged one each on two separate optical propagation paths of the recombination Mach-Zehnder interferometer. It then further comprises means for applying the following phase shifts:
a first phase shift, which is applied between two separate optical propagation paths of a first of the two secondary Mach-Zehnder interferometers, and which is equal to a sum of pi and a first phase shift component which varies sinusoidally as a function of time;
a second phase shift, which is applied between two separate optical propagation paths of a second of the two secondary Mach-Zehnder interferometers, and which is equal to a sum of pi and a second phase shift component which varies sinusoidally as a function of time, the first and second phase shift components which vary sinusoidally as a function of time having a common frequency and being in phase quadrature with respect to each other; and
a third phase shift, which is applied between the two optical propagation paths of the recombination Mach-Zehnder interferometer, and which is equal to plus or minus half of pi.
   Then, the common frequency of the first and second phase shift components which vary sinusoidally as a function of time determines a difference between the central wavelength value of the emitted pulse and a wavelength value of the initial laser radiation as produced by the laser emission source. For such embodiments with I/Q modulation, the recombination Mach-Zehnder interferometer and the two secondary Mach-Zehnder interferometers can be composed of an integrated optical circuit.

In preferred embodiments of the invention, at least one of the following additional characteristics may be optionally reproduced, alone or in a combination:
the LIDAR system may be adapted to provide an estimate of an air flow speed component when the system is pointed to emit the radiation pulses towards a portion of the atmosphere which contains suspended particles forming the target, the particles being backscatterers for the radiation;
each pulse may be monochromatic or quasi-monochromatic;
the transmission path may further be configured so that any two successively emitted pulses are spectrally disjoint by at least 10 MHZ, preferably at least 20 MHZ, and at most 2000 MHz;
the transmission path may further be configured so that the series of pulses repeats a constant sequence of central wavelength values for the pulses. Furthermore, differences between the central wavelength values which relate to pairs of successively emitted pulses, within the repeated sequence, can be constant;
the transmission path may further be configured so that a number of different central wavelength values for the pulses in the series is between 2 and 16 inclusive;
the transmission path may further be configured so that durations between successively emitted pulses vary over the course of the series of pulses. In this manner, a measurement area which would be obstructed by reflections of the radiation pulses on optical components of the transmission path, can be eliminated; and
the transmission path and/or the detection path may be implemented by optical fiber technology, to interconnect components of this transmission path and/or detection path.

### BRIEF DESCRIPTION OF FIGURES

The features and advantages of the invention will become more clearly apparent in the detailed description below of some non-limiting exemplary embodiments, with reference to the appended figures in which:

FIG. 1a is a block diagram of a pulsed LIDAR device with heterodyne detection as known from the prior art;

FIG. 1b groups two spectral diagrams relating to the operation of the LIDAR system of FIG. 1a;

FIG. 2 is a timing diagram which shows a possible spectral distribution for an operation of a LIDAR system according to the invention;

FIG. 3a corresponds to FIG. 1a for possible embodiments of LIDAR systems according to the invention;

FIG. 3b corresponds to FIG. 1b for the LIDAR systems of FIG. 3a;

FIG. 4 groups two diagrams which show possible temporal variations for a modulation signal used in first embodiments of the invention, as well as a corresponding spectral diagram; and

FIG. 5 is a block diagram of an I/Q modulator which can be used in second embodiments of the invention.

### DETAILED DESCRIPTION OF THE INVENTION

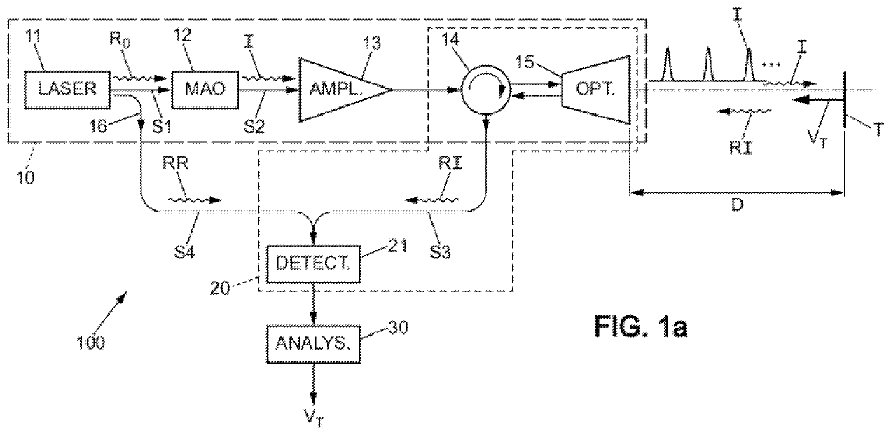

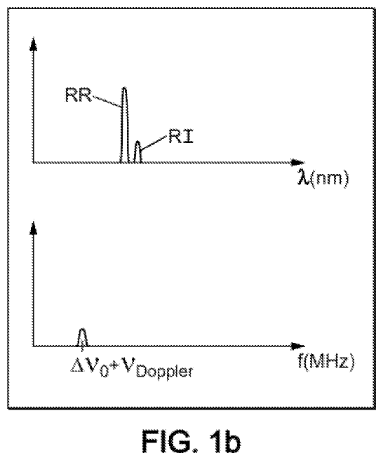

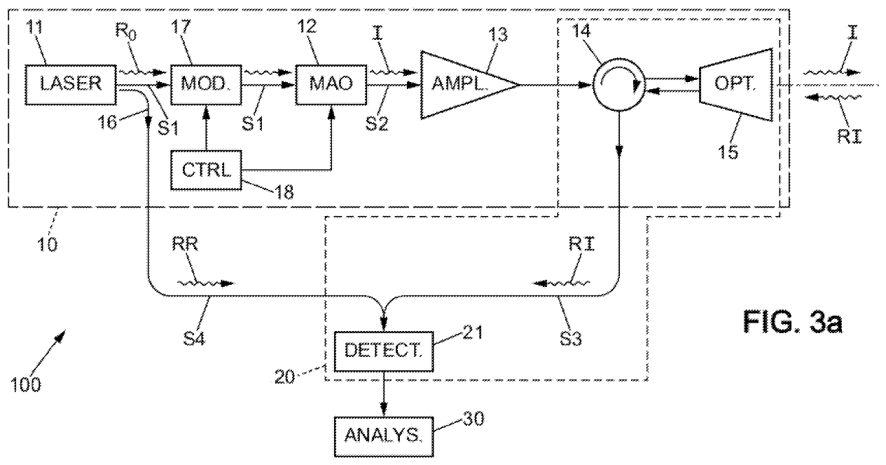

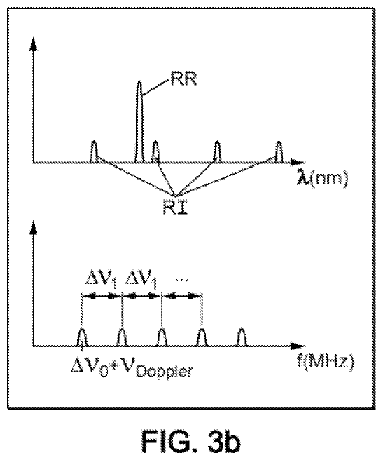

In these figures, all the components are represented symbolically, and identical references indicated in different figures designate elements which are identical or have identical functions. For clarity sake, components whose use in a LIDAR system is known to those skilled in the art, and which are not directly concerned by the invention, are not described below. In such case, their possible adaptation to the invention is within the reach of such persons skilled in the art. In FIG. 1a and FIG. 3a, the following references used have the meanings indicated here:
100 general designation for a pulsed LIDAR with heterodyne detection
10 transmission path
11 laser emission source, denoted LASER
12 frequency shift and pulse separating modulator, denoted MAO
13 optical amplifier, denoted AMPL.
14 optical circulator
15 emission optics, denoted OPT.
16 secondary output of the transmission path
20 detection path
21 heterodyne detector, denoted DETECT.
30 spectral analysis module, denoted ANALYS.

FIG. 1a shows a system 100 as known prior to the present invention.

Transmission path 10 comprises laser emission source 11, modulator 12, optical amplifier 13, optical circulator 14, and emission optics 15. Laser emission source 11 may be a continuous emission source, with an emission wavelength of approximately 1550 nm (nanometers) and a power of 600 μJ (microjoules), for example. It thus produces an initial laser radiation R₀ which is monochromatic or quasi-monochromatic. Initial laser radiation R₀ is transmitted to modulator 12. Modulator 12 can be an acousto-optic type of modulator. It is controlled to form, from the radiation it has received, identical pulses I of individual durations which can be between 200 ns (nanoseconds) and 800 ns, with a pulse repetition frequency PRF which can be 10 kHz (kilohertz) for example. Simultaneously, modulator 12 can be controlled to shift the optical frequency of the radiation by applying a frequency shift Δν₀ to it, which can be equal to 100 MHZ (megahertz) for example. Pulses I thus produced by modulator 12 are amplified by optical amplifier 13, then transmitted to emission optics 15 via optical circulator 14. Emission optics 15 can have a telescope structure, for example. The amplified pulses I are thus transmitted towards a target T, which is external to LIDAR system 100 and located at a distance D from it, measured along the direction of emission of system 100. In principle, separation distance D is less than range L of system 100, this range possibly being equal to approximately 15 km (kilometers) as an example.

All pulses I thus emitted by system 100 of FIG. 1a are identical and monochromatic or quasi-monochromatic.

Secondary output 16 is located in transmission path 10, between laser emission source 11 and the modulator 12 dedicated to shifting and separating the pulses I.

Detection path 20 shares emission optics 15 and optical circulator 14 with transmission path 10, and further comprises heterodyne detector 21. Within detection path 20, one function of optics 15 is to collect portions RI of pulses I which have been retroreflected or backscattered by target T. Heterodyne detector 21 is optically coupled so as to receive the portions RI of retroreflected or backscattered pulses which have been collected by optics 15, via optical circulator 14, and to receive simultaneously an optical reference signal RR which is collected from transmission path 10 via secondary output 16 of this transmission path. In other words, secondary output 16 is optically coupled to heterodyne detector 21 in addition to the output of optical circulator 14 which is dedicated to detection path 20. Heterodyne detector 21 may be a photodiode, in particular an ultrafast photodiode, on which are focused the optical reference signal RR which comes from secondary output 16 and the pulse portions RI which come from target T.

Spectral analysis module 30 is configured for spectrally analyzing the heterodyne detection signals produced by detector 21 during the operation of system 100. It is configured to deduce, from this spectral analysis, a value of a frequency shift which exists between optical reference signal RR and pulse portions RI. It is further configured to convert the value of the frequency shift thus obtained into a speed component value V_{T} for target T, parallel to the direction of emission of system 100. In a known manner: V_{T}=−λ₀·(νₘ−Δν₀)/2, where:
λ₀ designates the wavelength of laser emission source 11, equal to approximately 1550 nm in the example given above,
Δν₀ further designates the frequency shift applied by modulator 12, equal to 100 MHz in the example given above, and
νₘ is a frequency within the radio frequency domain, or RF domain, which is associated with a maximum intensity or a central peak position in the spectral decomposition of the heterodyne detection signal.

System 100 is preferably implemented using optical fiber technology. In such case, optical amplifier 13 can be of the type designated by EDFA, for “Erbium-Doped Fiber Amplifier”. Initial laser radiation R₀ is transmitted by a first optical fiber segment S1 from laser emission source 11 to modulator 12, then from the latter to amplifier 13 via a second optical fiber segment S2. In addition, retroreflected or backscattered pulse portions RI which are collected by optics 15 are injected into a third optical fiber segment S3 at the output of optical circulator 14 in order to convey them to heterodyne detector 21. In parallel, secondary output 16 of transmission path 10 is implemented by a fiber-optic coupler, and connected to heterodyne detector 21 via a fourth optical fiber segment S4.

For an operation of the just-described system 100 with a retroreflecting point target, the heterodyne detection signal has a sinusoidal variation at frequency νₘ. The upper diagram of FIG. 1b shows the spectral composition of the radiation received by heterodyne detector 21. The horizontal axis of this upper diagram of FIG. 1b identifies the wavelength values in the optical domain, denoted A and expressed in nanometers (nm). The vertical axis, in arbitrary units, identifies the spectral intensity values. The radiation received by heterodyne detector 21 comprises a first contribution which is composed of optical reference signal RR conveyed from secondary output 16, and a second contribution which corresponds to pulse portions RI which have been retroreflected by target T. For system 100 of FIG. 1a, optical reference signal RR is a portion of initial laser radiation R₀, such that the corresponding contribution in the upper diagram of FIG. 1b is a very narrow peak, denoted RR. When target T is located at a single location along the emission direction of system 100, the second contribution also has the shape of a narrow peak, denoted RI. The lower diagram of FIG. 1b shows the spectral composition of the heterodyne detection signal which corresponds to the spectral composition of the radiation received by detector 21 as shown in the upper diagram. The heterodyne detection signal then consists of a single peak, for which the frequency is νₘ=Δν₀+ν_{Doppler}, where ν_{Doppler}≈−2·V_{T}/λ₁, λ₁ being the wavelength value of the radiation as emitted by LIDAR system 100. The horizontal axis of the lower diagram in FIG. 1b identifies the frequency values in the RF domain, which are denoted f and expressed in megahertz (MHz). The vertical axis is again in arbitrary units for identifying the spectral intensity values of the heterodyne detection signal.

For an operation of system 100 which is dedicated to airspeed measurements, pulses I are backscattered by a multiplicity of targets distributed along the path of the pulse beam external to system 100, starting from emission optics 15. These targets, which are composed of particles or aerosols in suspension in the air, are pulled along as a function of the local speed of air movement existing at each location in the path of the beam. Those skilled in the art commonly refer to such a distribution of targets as “extended target”, “distributed target”, or “volume target”. Pulse portions RI which are collected by optics 15 then transmitted to detector 21 are thus spread over time, corresponding to different separation distances along the direction of emission of system 100, where partial backscattering of pulses I occurs. Furthermore, they are frequency shifted in a manner that varies depending on the local wind speed parallel to the direction of emission at the location where each partial backscattering occurs. The heterodyne detection signal then has more complex temporal variations. The spectral analysis carried out by module 30 is assumed to be known: for the result, it provides a series of speed values V_{T} which are assigned one-to-one to different values of the separation distance D. In a known manner, the resolution in separation distance D is determined by the individual duration of the emitted pulses I, being equal to this individual duration divided by twice the pulse propagation speed outside LIDAR system 100. In comparison to the diagrams of FIG. 1b, the peak which corresponds to pulse portions RI in the spectral composition of the radiation received by detector 21 is broadened. The peak of the spectral composition of the heterodyne detection signal, in the RF domain, is broadened in a correlated manner.

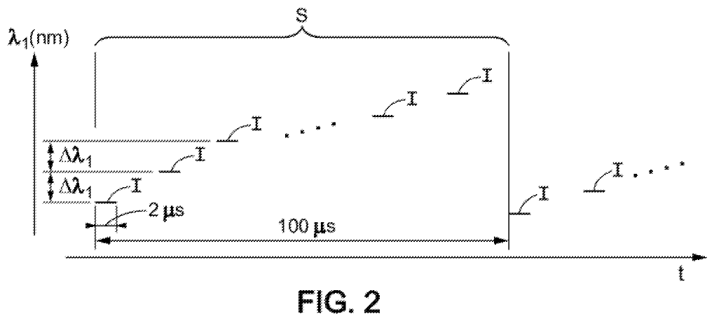

The horizontal axis of the diagram in FIG. 2 identifies the time, denoted t, and its vertical axis identifies the instantaneous emission wavelength λ₁ of a LIDAR system 100 which is in accordance with the invention. Wavelength λ₁ is expressed in nanometers (nm). In accordance with this diagram, a series of pulses I as emitted by LIDAR system 100 may be composed of repetitions, for example 100 repetitions, of a sequence S of several pulses I. For example, sequence S can have a duration of 100 μs (microseconds), and be composed of ten pulses I, each having an individual duration which can be 0.5 μs. Within sequence S, pulses I are advantageously distributed with separation durations which are variable between two successive pulses. Indeed, because of reflections of each pulse I on certain optical components in the terminal portion of transmission path 10, which are shared with detection path 20, the emission of each pulse I produces a detection signal whose very high intensity causes saturation of detector 21. This detection signal, which is due to internal reflections within system 100, is commonly called a Narcissus signal. For its duration, it prevents detection of pulse portions RI received by detector 21 at the same time as this Narcissus signal, and which correspond to pulses I previously emitted then retroreflected or backscattered by targets. Because of this, if the separation times between successively emitted pulses were all identical, the Narcissus signals would prevent measuring the speeds relating to targets located within constant intervals along the direction of emission, called blind intervals. Varying the times separating successive pulses within sequence S then makes it possible to obtain speed measurements for targets which are situated at any location within range of system 100, some of the pulses making it possible to fill in the blind intervals caused by other pulses. Each pulse I is monochromatic or quasi-monochromatic. Thus, the described sequence S corresponds to ten different values for emission wavelength λ. The order in which these ten wavelength values are produced by system 100 does not matter, as long as two successively emitted pulses have different wavelength values. Furthermore, the differences between these wavelength values can be any value, as long as any two pulses of sequence S are sufficiently separated spectrally so that the frequency shift possessed by retroreflected or backscattered pulse portions RI is contained within all the separation intervals between different pulses in sequence S. For illustration, in FIG. 2, successive pulses I have respective wavelength values which increase over time within sequence S, with constant increments for the wavelength value, denoted Δλ₁. Wavelength increment Δλ₁ corresponds to a frequency increment Δν₁ which is equal to −C−Δλ₁/λ₀². This latter increment can be equal to 200 MHZ, for example, in the RF domain. However, in general, the differences between pulse wavelength values may be inconstant from one pair of neighboring values to another.

In the example just described, the repetition frequency of sequence S is equal to 10 KHz, while the pulse frequency which is in effect for measuring target speeds, i.e. frequency PRF, is equal to the product of this repetition frequency of sequence S and the number of pulses in the sequence, i.e. 100 KHz.

Such operation in accordance with the invention can be produced by a LIDAR system 100 as represented in FIG. 3a. This system has a hardware architecture similar to that of FIG. 1a, except that transmission path 10 further comprises an additional modulator 17, denoted MOD, and a controller 18, denoted CTRL. Modulator 17 is inserted in first optical fiber segment S1, between laser emission source 11 and electro-acoustic modulator 12. Two possible constructions for modulator 17 will be described below. Modulator 17, in association with controller 18, transforms initial laser radiation R₀ into a series of monochromatic pulses having variable wavelength values as described above with reference to FIG. 2. Controller 18 simultaneously controls modulator 12 to produce variable separation durations between successive pulses. In addition, modulator 12 applies frequency shift Δν₀ to each of the pulses as produced by modulator 17.

When retroreflected, each pulse I is spectrally shifted due to the Doppler effect. Given that frequency increment Δν₁ is much lower than the optical frequency which corresponds to wavelength λ₀, all the pulses undergo the same Doppler effect frequency shift ν_{Doppler}. In addition, frequency increment Δν₁ is chosen to be greater than all values feasibly expected for the Doppler effect frequency shift ν_{Doppler} added to frequency shift Δν₀.

Secondary output 16 of transmission path 10 is now located between laser emission source 11 and modulator 17. In this manner, optical reference signal RR which is conveyed to heterodyne detector 21 is still composed of a portion of initial laser radiation R₀. In particular, it is still monochromatic.

As shown by the upper diagram in FIG. 3b, the spectral composition of the radiation received by heterodyne detector 21 then still comprises peak RR which corresponds to the emission from laser source 11, but also comprises several additional peaks RI which correspond to the pulse portions which were retroreflected or backscattered then collected by optics 15. These peaks RI come from all the wavelength values of emitted pulses I, and contain the measurement information. They are spectrally shifted relative to the pulses I of ν_{Doppler}, in terms of optical frequency. During heterodyne detection, each peak RI forms an interference with peak RR. As shown in the lower diagram in FIG. 3b, the heterodyne detection signal is then composed of as many peaks as there are different wavelength values for pulses I. The two diagrams in FIG. 3b correspond to the case where the wavelength values of pulses I are separated according to a constant frequency increment Δν₁. Spectral analysis module 30 then determines the value of the Doppler effect frequency shift ν_{Doppler} based on the RF frequency values measured for all peaks in the heterodyne detection signal. For example, an elementary value is determined for ν_{Doppler} based on the central frequency value of each of the peaks of the heterodyne detection signal, and the final value of ν_{Doppler} is calculated by averaging these elementary values. Given that all peaks in the heterodyne detection signal correspond to contributions that are incoherent with each other, the heterodyne detection signal has a signal-to-noise ratio value that is increased by a factor of n^{1/2}, where n is the number of different wavelength values for pulses I.

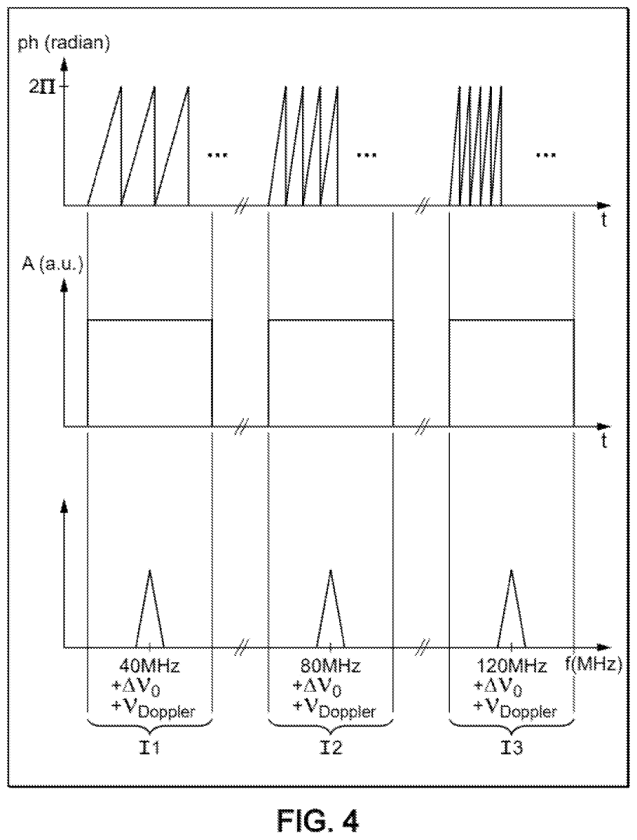

In first embodiments of the invention, monochromatic pulses I with variable wavelength values within sequence S can be produced by serrodyne modulation. In this case, modulator 17 can be an electro-optical type of modulator, and controller 18 is adapted to apply a serrodyne modulation signal to the control input of modulator 17. The principle of such modulation is assumed to be known to the skilled person. If necessary, one can refer to the article entitled “New coherent Doppler Lidar engine integrating optical transceiver with FPGA signal processor”, by Toshiyuki Ando, Eisuke Haraguchi(a) and Hitomi Ono(a), 18th Coherent Laser Radar Conference (2016). According to the first two diagrams in FIG. 4, this modulation signal is composed, for each pulse I of radiation to be emitted, of a succession of linear phase ramps which are identical and temporally joined together. Each phase ramp varies individually from 0 to 2π. The succession of phase ramps occupies the entire duration of the pulse. These phase ramps cause an increase in the speed of variation in the phase of the radiation, thus producing the desired optical frequency shift for the pulse in question. This optical frequency shift is directly equal to the phase ramp slope, divided by 2·π. This phase ramp slope, which is constant for the duration of each pulse I, varies between two successive pulses. It can be positive or negative, depending on whether the wavelength of the pulse at the output from modulator 17 is less than or greater than wavelength λ₀ of initial laser radiation R₀. The upper diagram in FIG. 4 shows such a serrodyne modulation signal. The horizontal axis identifies the time t, and the vertical axis identifies the phase shift created by the modulation, denoted ph. and expressed in radians. The first pulse represented, denoted 11, can correspond to an optical frequency shift which is equal to 40 MHz relative to the optical frequency of the initial laser radiation R₀. For this, the slope of its phase ramps is equal to 2·π·40 MHz. The phase ramps of the second pulse, denoted 12, are twice as steep as those of pulse I1, and the corresponding optical frequency shift of pulse I2 is then equal to 80 MHZ. Similarly, the phase ramps of the third pulse, denoted I3, are three times as steep as those of pulse I1, and the optical frequency shift of pulse I3 is then equal to 120 MHZ, etc. For clarity in the diagrams in FIG. 4, only three of the ten pulses of sequence S have been represented. In the operation of LIDAR system 100 of FIG. 3a, shift Δν₀ produced by modulator 12 is added to the previous shifts produced by modulator 17. The intermediate diagram of FIG. 4 shows that the serrodyne modulation does not modify the amplitude of the radiation transmitted by modulator 17. The horizontal axis of this intermediate diagram again identifies the time t, and the vertical axis identifies, in arbitrary units (a.u.), the attenuation factor for the attenuation produced by modulator 17 on the intensity of the radiation, and which is denoted A. This factor is substantially constant, and is as close as possible to one unit. Finally, the lower diagram in FIG. 4 shows the frequency distribution of the resulting heterodyne detection signal. The horizontal axis of this lower diagram identifies the values of the frequency f in the RF domain, and the vertical axis identifies the power spectral density of the heterodyne detection signal. The peak which corresponds to pulses 11, in all the repetitions of the sequence S of emitted pulses, is therefore centered on the value 40 MHZ+Δν₀+ν_{Doppler}, the peak which corresponds to pulses 12 is centered on the value 80 MHz+Δν₀+ν_{Doppler}, the peak which corresponds to pulses 13 is centered on the value 120 MHZ+Δν₀+ν_{Doppler}, etc. This example of serrodyne modulation corresponds to the frequency increment Δν₁=40 MHZ.

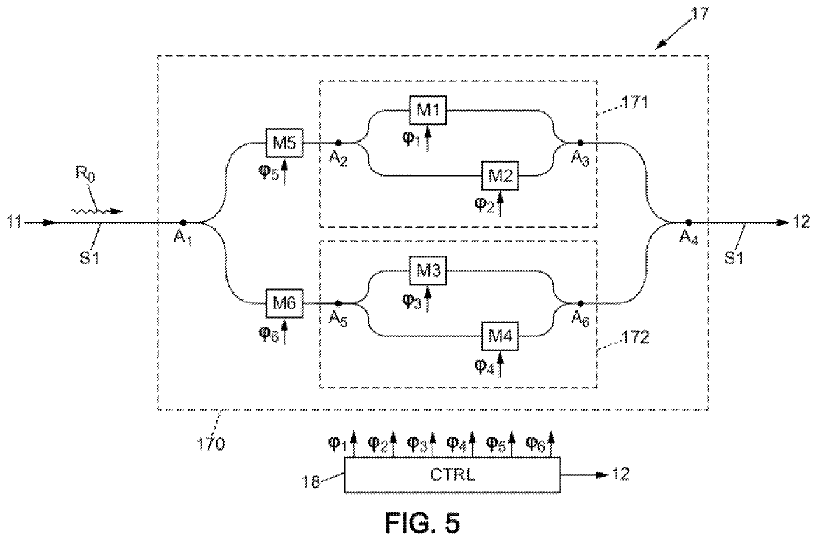

In second embodiments of the invention, the monochromatic pulses I at variable wavelength values can be produced by I/Q modulation. In this case, modulator 17 can be of a type as described in the article entitled “Tunable Frequency Shifter Based on LiNbO₃ I/Q Modulators”, by Alexandre Mottet, Nicolas Bourriot and Jérôme Hauden, Photline Technologies, ZI Les Tilleroyes-Trépillot, 16 rue Auguste Jouchoux, 25000 Besanøon, France, or in the article entitled “Integrated optical SSB modulator/frequency shifter”, by Masayuki Izutsu, Shinsuke Shikama and Tadasi Sueta, IEEE Journal of Quantum Electronics 17, no. 11 (November 1981): 2225 27, https://doi.org/10.1109/JQE.1981.1070678. It is composed of a main interferometer of the Mach-Zehnder type, also called a recombination interferometer, which is connected to receive initial laser radiation R₀ from laser emission source 11 as input, and connected at the output to the optical input of acousto-optic modulator 12. In accordance with FIG. 5, this recombination interferometer, designated by the reference 170, has two optical propagation paths which are arranged in parallel between source 11 and modulator 12: path A₁A₂A₃A₄ and path A₁A₅A₆A₄. Path A₁A₂A₃A₄ comprises an electro-optical modulator M5 between points A₁ and A₂, and another Mach-Zehnder interferometer between points A₂ and A₃, which is called a secondary interferometer and designated by the reference 171. Secondary interferometer 171 itself comprises two optical propagation paths which are arranged in parallel between points A₂ and A₃. Each of these two paths of secondary interferometer 171 comprises an electro-optical modulator, respectively M1 and M2. Path A₁A₅A₆A₄ has an identical structure to that of path A₁A₂A₅A₄. It comprises another electro-optical modulator M6 between points A₁ and A₅, and another secondary Mach-Zehnder interferometer between points A₅ and A₆, which is designated by the reference 172. Secondary interferometer 172 itself comprises two optical propagation paths which are arranged in parallel between points A₅ and A₆. Each of these last two paths comprises an electro-optical modulator, respectively M3 and M4. Such a modulator 17 can be implemented in the form of an integrated optical circuit, with electro-optical modulators M1-M6 implemented on the basis of portions of lithium niobate (LiNbO₃) associated with respective electrodes. Several technologies for integrated optical circuits are known to those skilled in the art, which can be used for such an embodiment of a LIDAR system 100 according to the invention.

Controller 18 applies electrical voltages to the respective electrodes of electro-optical modulators M1-M6, so that each of these generates an optical phase shift for the portion of initial laser radiation R₀ which it transmits. Thus, modulator Mi generates optical phase shift qi, where i is a natural integer index which varies from 1 to 6. Under these conditions, secondary Mach-Zehnder interferometer 171 applies a first phase shift between its two optical propagation paths which connect points A₂ and A₃. This first phase shift is Φ1=φ₁−φ₂. Similarly, secondary Mach-Zehnder interferometer 172 applies a second phase shift, Φ2, between its two optical propagation paths which connect points A₅ and A₆: Φ₂=φ₃−φ₄. Finally, recombination Mach-Zehnder interferometer 170 applies a third phase shift, Φ₃, between the two optical propagation paths A₁A₂A₅A₄ and A₁A₅A₆A₄:Φ₃=φ₅−φ₆. Modulator 17 thus has an optical frequency shifting function for initial laser radiation R₀ when controller 18 applies voltages to electro-optical modulators M1-M6, such that:

$${Φ}_{1} = {φ}_{1} - {φ}_{2} = π + α \cdot sin ( Δ {v}_{1} , \cdot t ) , \\ {Φ}_{2} = {φ}_{3} - {φ}_{4} = π + α \cdot sin ( Δ {v}_{1} \cdot t + \pm π / 2 ) , and \\ {Φ}_{3} = {φ}_{5} - {φ}_{6} = \pm π / 2.$$

Phase shifts Φ₁ and Φ₂ thus have sinusoidal variations as a function of time t, according to a frequency which is intended to be equal to the optical frequency shift Δν₁ which was introduced above, and which belongs to the RF domain. To produce the control voltages for electro-optical modulators M1-M6, controller 18 may incorporate an electrical generator of the AWG type, for “Arbitrary Waveform Generator”.

Although the implementation of distance resolution has not been described in connection with the embodiments of the invention presented above to obtain speed measurement results which relate to sampled separation distance values, the principle of obtaining such a distance resolution can be used as described for system 100 of FIG. 1a.

For all embodiments of the invention, each pulse can have an individual peak power value which is just below a threshold for the stimulated Brillouin scattering which occurs in optical fiber segments S1 and S2 as well as in optical amplifier 13, optical circulator 14, and the optical fiber segments between these and leading to emission optics 15. At identical values for the range L of system 100, the total number of pulses is multiplied by the number n of different wavelength values for the pulses, while the individual energy of each pulse can be identical to that used before the invention. An improvement by a factor of n^{1/2} is thus obtained for the operation of the LIDAR system with heterodyne detection. Pulsed LIDAR systems with heterodyne detection in accordance with the invention are therefore particularly suitable for measurement conditions where the retroreflected or backscattered pulse portions have low or very low power. They are therefore particularly suitable for carrying out airspeed measurements.

It is understood that the invention can be reproduced while modifying secondary aspects of the embodiments described in detail above, while retaining at least some of the cited advantages. In particular, the following modifications are possible:
some of the components used in the described embodiments can be replaced by other components or by combinations of components which produce equivalent functions. For example, each acousto-optic modulator can be replaced by a semiconductor optical amplifier, or SOA, used as a modulator;
with respect to the LIDAR system architecture of FIG. 3a, secondary output 16 of transmission path 10 can be moved between electro-optical modulator 17 and electro-acoustic modulator 12. An operation of heterodyne-type detection is still obtained by connecting the reference input of detection path 20 to secondary output 16 in this new position. The heterodyne detection signal then consists of one or more primary peak(s) which correspond(s) to the detection of one or more target(s) present within the range L of the LIDAR system as limited by the pulse repetition frequency PRF, and secondary peak(s) which is (are) shifted primarily according to the spectral differences between the pulses in the series, and which correspond to one or more additional target(s) present beyond range L, and for which the pulse portions they backscatter are detected after the emission of at least one subsequent pulse following the one which gave rise to each pulse portion backscattered by one of the additional targets; and
all the numerical values which have been cited are for illustrative purposes only, and can be changed according to the application considered for the pulsed LIDAR system with heterodyne detection.

1-11. (canceled)

12. A pulsed LIDAR system, adapted to determine a value of a Doppler effect frequency shift which is undergone by a series of radiation pulses successively emitted by the system towards a target, between portions of the pulses as received after retroreflection or backscattering on the target and said pulses as emitted by the system, and to provide, based on the value determined for the frequency shift, an estimate of a speed component of the target which is parallel to an optical direction of emission of the system,
the system comprising:
a transmission path, configured to produce the series of pulses,
a detection path, configured to detect the pulse portions received after retroreflection or backscattering on the target, and to produce heterodyne detection signals which correspond to the pulses of the series, and
a spectral analysis module, adapted to carry out a spectral analysis of the heterodyne detection signals, so that the value of the frequency shift results from heterodyne detection contributions which correspond to the pulses of the series,
wherein the system is adapted to provide an estimate of an air flow speed component when the system is pointed to emit the radiation pulses towards a portion of atmosphere which contains suspended particles forming the target, the particles being backscatterers for said radiation, and wherein:
the transmission path is further configured so that two pulses successively emitted towards the target are spectrally disjoint and associated with respective central wavelength values which are different, and
the system is adapted so that the value of the Doppler effect frequency shift which is determined by the spectral analysis module results from a combination of several heterodyne detection contributions which respectively correspond to the spectrally disjoint pulses and for which the central wavelength values are different, by determining an elementary value for the Doppler effect frequency shift based on each heterodyne detection spectral contribution, independently of the other heterodyne detection spectral contributions, and then averaging the elementary values to calculate a final value of the Doppler effect frequency shift.

13. The pulsed LIDAR system according to claim 12, wherein the transmission path is further configured so that any two successively emitted pulses are spectrally disjoint by at least 10 MHz, preferably at least 20 MHz, and at most 2000 MHz.

14. The pulsed LIDAR system according to claim 12, wherein the transmission path is further configured so that the series of pulses repeats a constant sequence of central wavelength values for the pulses.

15. The pulsed LIDAR system according to claim 14, wherein the transmission path is further configured so that differences between the central wavelength values which relate to pairs of successively emitted pulses, within the repeated sequence, are constant.

16. The pulsed LIDAR system according to claim 12, wherein the transmission path is further configured so that a number of different central wavelength values for the pulses in the series is between 2 and 16 inclusive.

17. The pulsed LIDAR system according to claim 12, wherein the transmission path is further configured so that durations between successively emitted pulses vary over the course of the series of pulses.

18. The LIDAR system according to claim 12, wherein the transmission path comprises:
a laser emission source, adapted to produce an initial laser radiation;
at least one modulator, arranged to modify the initial laser radiation in accordance with a modulation signal applied to at least one control input of said modulator; and
a controller, connected so as to apply the modulation signal to said at least one control input,
said modulation signal being such that the initial laser radiation is transformed by the modulator into the series of pulses in which two successive pulses are spectrally disjoint and have central wavelength values which are different,
and a reference input of the detection path, which is used for heterodyne detection, is connected to a secondary output of the transmission path which is located between the laser emission source and the modulator.

19. The LIDAR system according to claim 18, wherein the modulator is a phase modulator,
and the modulation signal is a phase modulation signal composed of temporally disjoint sequences of linear phase-shift ramps, the linear phase-shift ramps being identical and successive within each sequence and having different slopes between different sequences, and the sequences of linear phase-shift ramps corresponding one-to-one to the pulses emitted by the LIDAR system.

20. The LIDAR system according to claim 18, wherein the modulator comprises a recombination Mach-Zehnder interferometer, and two secondary Mach-Zehnder interferometers which are arranged one each on two separate optical propagation paths of the recombination Mach-Zehnder interferometer, and comprises means for applying the following phase shifts:
a first phase shift, which is applied between two separate optical propagation paths of a first of the two secondary Mach-Zehnder interferometers, and which is equal to a sum of pi and a first phase shift component which varies sinusoidally as a function of time;
a second phase shift, which is applied between two separate optical propagation paths of a second of the two secondary Mach-Zehnder interferometers, and which is equal to a sum of pi and a second phase shift component which varies sinusoidally as a function of time, said first and second phase shift components which vary sinusoidally as a function of time having a common frequency and being in phase quadrature with each other; and
a third phase shift, which is applied between the two optical propagation paths of the recombination Mach-Zehnder interferometer, and which is equal to plus or minus half of pi, the common frequency of the first and second phase shift components which vary sinusoidally as a function of time determining a difference between the central wavelength value of the emitted pulse and a wavelength value of the initial laser radiation which is produced by the laser emission source.

21. The LIDAR system according to claim 12, wherein at least one of the transmission path and the detection path is implemented by optical fiber technology, to interconnect components of said transmission path or detection path respectively.
